(19) United States
(12) Patent Application Publication
(10) Pub. No.: US 2023/0318371 A1
(43) Pub. Date: Oct. 5, 2023

(54) ROTOR ASSEMBLY WITH PRINTED MAGNETS

(71) Applicant: BorgWarner Inc., Auburn Hills, MI (US)

(72) Inventors: Jeffrey Carter, Mirifeld (GB); Tyler Garrard, Arden, NC (US)

(21) Appl. No.: 18/192,194

(22) Filed: Mar. 29, 2023

Related U.S. Application Data
(60) Provisional application No. 63/327,535, filed on Apr. 5, 2022.

(51) Int. Cl. H02K 1/22; H02K 7/00

(52) U.S. Cl. CPC H02K 1/22; H02K 7/003

(57) ABSTRACT

A rotor assembly included in an electric motor having a magnetic layer, including an additive manufacturing magnetic substrate, coupled to an output shaft of an electric motor; and an insulating layer, including an additive manufacturing insulating substrate, coupled to the output shaft axially adjacent to the magnetic layer.

### CROSS-REFERENCE TO RELATED APPLICATIONS

This application claims priority pursuant to 35 U.S.C. 119(a) to U.S. Application No. 63/327,535, filed Apr. 5, 2022, which application is incorporated herein by reference in its entirety.

### TECHNICAL FIELD

The present application relates to electric motors and, more particularly, to rotor assemblies used with electric motors.

### BACKGROUND

Electric motors generally include a stator and a rotor assembly. The design and manufacture of the components of the rotor assembly can vary widely. For example, the rotor assembly can include a frame that securely holds magnets that are angularly spaced around a motor shaft. The assembly of these components can be challenging.

### SUMMARY

In one implementation, a rotor assembly included in an electric motor has a magnetic layer, including an additive manufacturing magnetic substrate, coupled to an output shaft of an electric motor; and an insulating layer, including an additive manufacturing insulating substrate, coupled to the output shaft axially adjacent to the magnetic layer.

In another implementation, a rotor assembly included in an electric motor has a magnetic layer, including an additive manufacturing magnetic substrate, coupled to an output shaft of an electric motor; and an insulating layer, including an additive manufacturing insulating substrate, coupled to the output shaft such that a radial surface of the magnetic layer abuts a radial surface of the insulating layer.

### BRIEF DESCRIPTION OF THE DRAWINGS

FIG. 1 is a perspective view depicting an implementation of an electrically-controlled turbocharger assembly;

FIG. 2 is a cross-sectional view depicting an implementation of an electrically-controlled turbocharger assembly;

FIG. 3A is a perspective view depicting an implementation of a portion of a rotor assembly that can be used with an electrically-controlled turbocharger assembly;

FIG. 3B is a perspective view depicting an implementation of a portion of a rotor assembly that can be used with an electrically-controlled turbocharger assembly;

FIG. 4 is a partially exploded view depicting an implementation of a rotor assembly that can be used with an electrically-controlled turbocharger assembly;

FIG. 5 is a cross-sectional view depicting an implementation of a rotor assembly that can be used with an electrically-controlled turbocharger assembly;

FIG. 6 is a perspective view depicting another implementation of a rotor assembly that can be used with an electrically-controlled turbocharger assembly; and

FIG. 7 is a perspective view depicting another implementation of a rotor assembly that can be used with an electrically-controlled turbocharger assembly.

### DETAILED DESCRIPTION

A rotor assembly can be formed from alternating layers of magnetic layers and insulating layers comprising materials formed by additive manufacturing (AM). The magnetic layer can be formed or printed using an AM magnetic substrate and the insulating layer formed or printed using an AM insulating substrate along an axial direction such that radial surfaces of the magnetic layer and the insulating layer abut each other. AM manufacturing can also be referred to as three-dimensional (3D) printing. In the past, rotor assemblies have been formed from discrete magnets that exists in small segments and are later assembled together with non-electrically-conductive adhesive positioned in between the small segments. Such a process can be time consuming and messy. In contrast, a rotor assembly including alternating magnetic and insulating layers of AM substrate applied with an AM machine, such as a laser jet or a binder jet, can be formed more quickly and simply. The rotor assembly described herein can reduce Eddy currents that flow in the magnetic layers, especially in electric motors that operate at relatively high frequencies, such as electrically-controlled turbochargers.

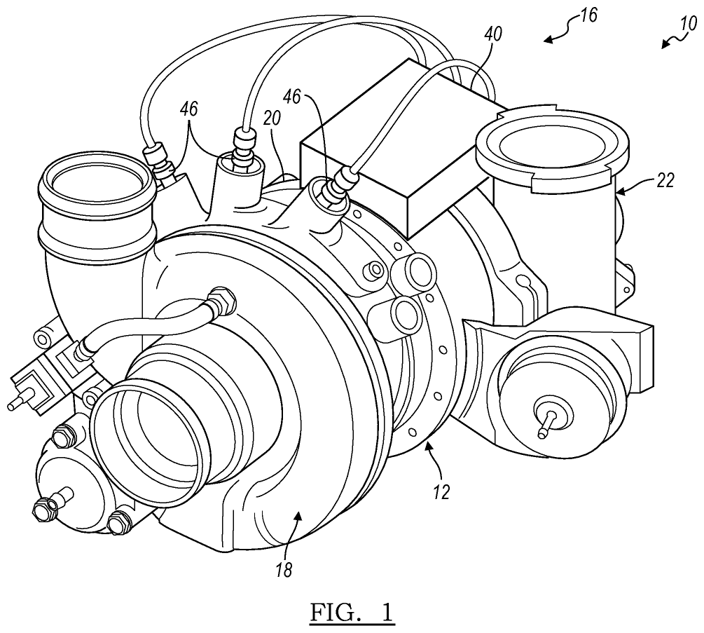

FIGS. 1-2 depict one implementation of an electrically-controlled turbocharger assembly 10 that includes an electrically-controlled turbocharger 12 and an electronics assembly 14 that includes a PCB received by a housing 16. The electrically-controlled turbocharger 12 includes a compressor portion 18, an electric motor 20, and an exhaust portion 22 that are assembled to form a structure that receives the components of the turbocharger 12. A turbine shaft 24 extends through the compressor portion 18, the electric motor 20, and the exhaust portion 22 as can be appreciated in FIG. 2. At one end, the turbine shaft 24 couples with a compressor turbine 26, located in the compressor portion 18, that spins to compress air, which is ultimately supplied to an intake plenum (not shown) of an internal combustion engine (ICE). Another portion of the turbine shaft 24 that is axially-spaced from the compressor turbine 26 and located in the electric motor 20 couples with a rotor assembly 28 of the electric motor 20. The turbine shaft 24 can also be viewed as an output shaft of the electric motor 20. The rotor assembly 28 can be positioned concentrically relative to a stator 32 included in the electric motor 20. One or more bearings 34 are included in the electric motor 20 and axially spaced along the turbine shaft 24 to support and stabilize the turbine shaft 24, the compressor turbine 26, the rotor assembly 28, and an exhaust turbine 36 as these elements rotate within the turbocharger 12 during operation. The exhaust turbine 36 is coupled to an end of the turbine shaft 24 distal to the compressor turbine 26 located in the exhaust portion 22. The electronics assembly 14 is coupled to the compressor portion 18 of the electrically-controlled turbocharger 12 as is shown in FIGS. 1-2.

The compressor portion 18 includes a compressor turbine chamber in which the compressor turbine 26 spins in response to the rotation of the turbine shaft 24 and compresses air that is ultimately supplied to the intake manifold of the ICE. The compressor turbine 26 is coupled with the turbine shaft 24 that extends from the compressor portion 18 into the electric motor 20 and the exhaust portion 22. The rotor assembly 28 is coupled to the turbine shaft 24 so that the rotor assembly 28 and the turbine shaft 24 are not angularly displaced relative to each other. When combined, the rotor assembly 28 extends axially relative to the shaft 24 in close proximity to the stator 32. The stator 32 can include a plurality of windings that convey electrical current from the power electronics and induce the angular displacement of the rotor assembly 28 and the turbine shaft 24 coupled to the rotor assembly 28 relative to the stator 32. In one implementation, the stator 32 and the rotor 28 can be implemented as a direct current (DC) brushless motor that receives DC voltage from a vehicle battery. The amount of DC voltage applied to the stator 32 may be greater than 40 volts (V), such as can be provided by a modern 48V vehicle electrical system. Other implementations are possible in which a vehicle electrical system uses higher voltages, such as 400V and 800V. Electrical connectors 46 are included on the electrically actuated turbocharger 12 and communicate electrical power from an electrical source to a PCB that regulates electrical current supplied to the electrical motor of the electrically-controlled turbocharger 12.

The exhaust portion 22 is in fluid communication with exhaust gases generated by the ICE. As the revolutions per minute (RPMs) of the crankshaft of the ICE increase, the volume of the exhaust gas generated by the ICE increases and correspondingly increases the pressure of exhaust gas in the exhaust portion 22. This increase in pressure can also increase the angular velocity of the exhaust turbine 36 that communicates rotational motion to the compressor turbine 26 through the turbine shaft 24. In this implementation, the compressor turbine 26 receives rotational force from the exhaust turbine 36 and the electric motor 20. More particularly, when the ICE is operating at a lower RPM, the electric motor 20 can provide rotational force to the compressor turbine 26 even though exhaust gas pressure within the exhaust portion 22 is relatively low. As the ICE increases the RPM of the crankshaft, exhaust gas pressure within the exhaust portion 22 can build and provide the rotational force that drives the compressor turbine 26. The compressor turbine chamber 38 is in fluid communication with a compressor inlet 40 that draws air from the surrounding atmosphere and supplies it to the compressor turbine 26. As the PCB selectively provides current to the windings of the stator 32, the rotor assembly 28 is induced to rotate and impart that rotation on the turbine shaft 24 and the compressor turbine 26.

However, it should be appreciated that the concepts described herein can be applied to electrically actuated turbochargers that are configured in different ways. For example, the electrically actuated turbocharger can be implemented using a compressor portion and an electric motor while omitting the exhaust portion. In such an implementation, the turbocharger includes a compressor turbine coupled to the electric motor via a turbine shaft without relying on an exhaust turbine to also be coupled to the turbine shaft. This implementation can sometimes be referred to as an electric supercharger because forced induction in this implementation relies solely on the rotational force provided by an electric motor rather than also using an exhaust turbine that is rotationally driven by exhaust gases. Also, the concepts described herein can also be applied to electric motors used in non-electrically-controlled turbocharger applications as well. For instance, the rotor assemblies described herein can be used in an electric traction motor as are included in hybrid-electric or battery-electric vehicles.

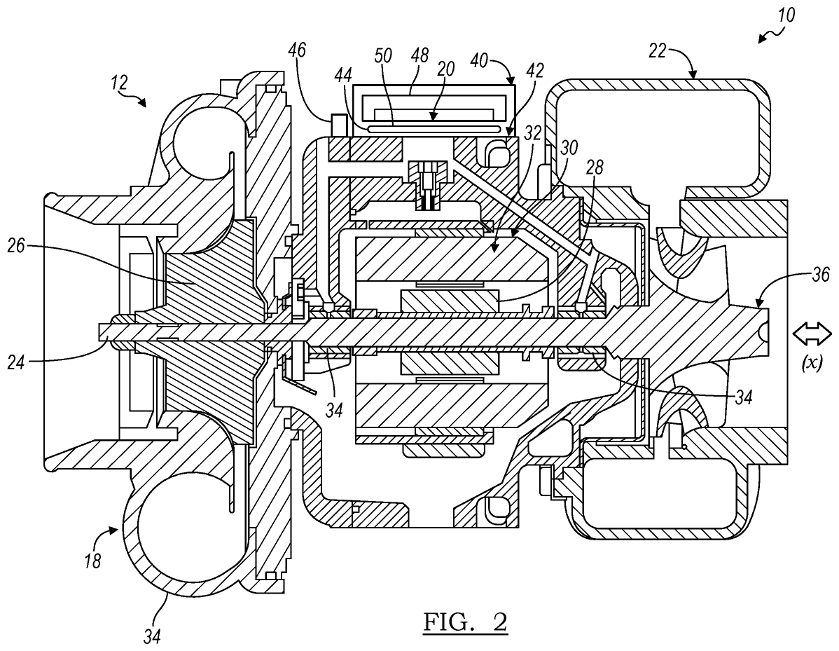

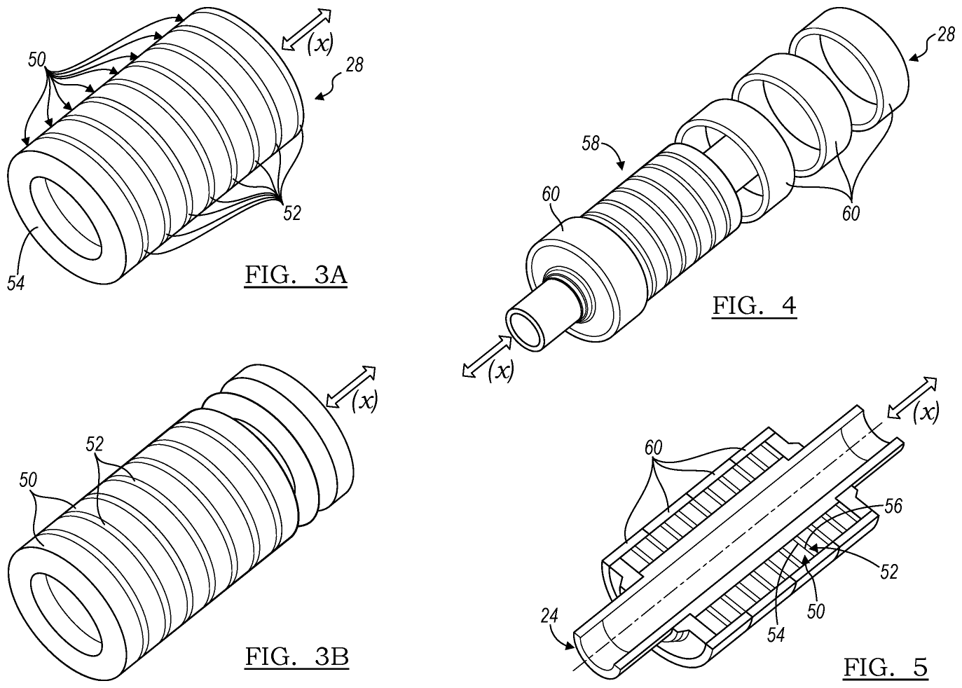

Turning to FIGS. 3-5, an implementation of a rotor assembly 28 is shown. The rotor assembly 28 includes alternating magnetic layers 50 and insulating layers 52 of additive manufacturing (AM) substrate created by an AM machine. The rotor assembly 28 can include the turbine shaft 24, or alternatively an output shaft of an electric motor. The rotor assembly 28 can include an axial stack up along an axis of rotation (x) comprising a magnetic layer 50 created using an AM machine having an additive manufacturing magnetic substrate having magnetic properties. The assembly 28 can also include an insulating layer 52, axially adjacent to the magnetic layer 50, acting as an electric insulator, and optionally a thermal conductor, created using an AM substrate having insulating properties applied using an AM machine. The rotor assembly 28 can have alternating magnetic layers 50 and insulating layers 52 that extend in the axial direction (x) such that a radial surface 54 of the magnetic layers 50 abuts a radial surface 56 of the insulating layers 52 created using an AM machine. Additive manufacturing machines may also be known commonly as three-dimensional (3D) printing as discussed above. The magnetic layer 50 and the insulating layer 52 can be formed from a substrates applied by an AM machine (not shown), such as a 3D printer, laser jet, or a binder jet.

In one example, the magnetic substrate can initially exist as a powder comprising neodymium, iron, and boron that can be applied by the AM machine to form a neodymium magnet layer 50. In other implementations, different materials can be used to form the magnetic substrate, such as samarium cobalt. In one implementation, the magnetic layer 50 can be 1-2 millimeters (mm) in axial thickness as measured along the turbine shaft 26. The AM machine can convert the magnetic substrate into a three-dimensional shaped magnet layer 50 that is or can be coupled to the turbine shaft 26. The insulating layer 52 can be formed from the insulating substrate applied by the AM machine to the radial surface 54 of the magnetic layer 50. The insulating substrate can initially exist as a powder comprising an electrical insulator and, optionally, a thermal conductor. One example of an insulating substrate that can insulate electrically yet conduct thermally is aluminum nitride. The AM machine can convert the insulating substrate into a three-dimensional shaped insulating layer 52 that abuts the magnetic layer 50 and is or can be coupled to the turbine shaft 26. In one implementation, the insulating layer 52 can be 1-2 micrometers (μm). However, it should be appreciated that the thickness of insulating layers can vary and generally speaking the insulating layer is as thick as needed to provide electrical insulation but no thicker. Exemplary thicknesses of magnetic layers and insulating layers have been provided. However, it should be appreciated that these thicknesses can vary depending on desired performance of the rotor assembly 28. For example, the thicknesses can vary depending on the desired cooling at the center of the rotor assembly 28. The rotor assembly 28 can comprise alternating magnetic and insulating layers 50, 52, as desired by the application. In this implementation, the magnetic layers 50 and the insulating layers 52 are shown to be relatively circular outer dimensions and inner dimensions but it should be appreciated that the layers 50, 52 can be formed in different shapes, such as layers having an oval outer diameter. The layers 50, 52 can be coated on an axial outer surface 58 to improve heat rejection and provide an electrical shield that may reduce the penetration of high-frequency fields thereby reducing Eddy currents in the magnetic layers 50. The coating can facilitate the addition of one or more sleeves concentrically positioned relative to the layers 50, 52.

After the rotor assembly 28 includes the desired quantity of magnetic layers 50 and insulating layers 52, it is possible to further densify the layers 50, 52 using sintering or high-isostatic-pressure (HIP) operation. The rotor assembly 28 can also include one or more sleeves 60 that engage the axial outer surface 58 of the magnetic layers 50 and the insulating layers 52 to provide structural support for the assembly 28. The axial outer surface 58 of the sleeves 60 can include a relatively low coefficient of friction. The sleeves 60 can be formed from a metal alloy in some applications, but other materials are possible, such as carbon-reinforced polymer.

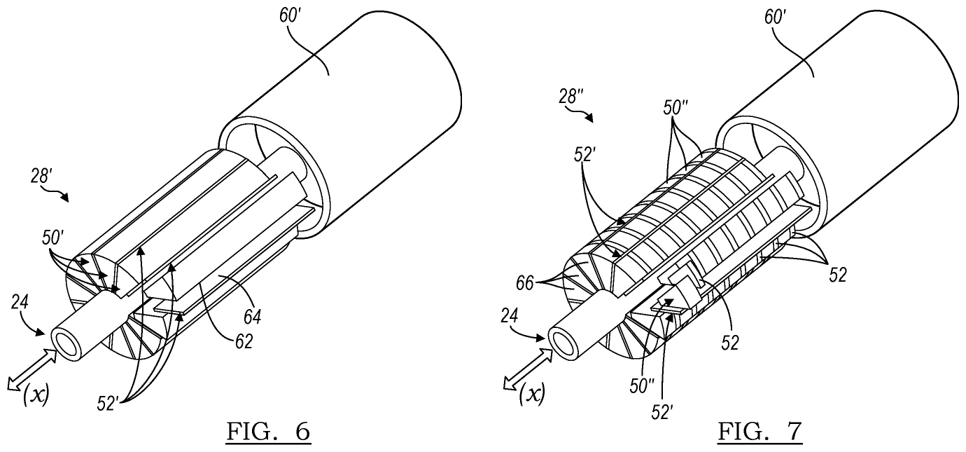

FIG. 6 depicts another implementation of a rotor assembly 28′. The rotor assembly 28′ includes magnetic layers 50′ and insulating layers 52′ of additive manufacturing (AM) substrate created by an AM machine. The magnetic layers 50′ can be formed as described above, but may be shaped such that they are elongated and extend axially along the output shaft 24. In some implementations, the magnetic layers 50′ can extend axially along the output shaft 24 from one end of the rotor 28 to an opposite end of the rotor 28. Insulating layers 52′ can also extend axially along the output shaft 24. An axial surface 62 of the magnetic layer 50′ can abut an axial surface 64 of the insulating layer 52′.

FIG. 7 depicts yet another implementation of a rotor assembly 28″. The rotor assembly 28″ can include a plurality of magnetic layers 50″ and insulating layers 52 as well as axially-extending insulating layers 52′. In this implementation, the magnetic layers 50″ can each comprise a plurality of individual magnetic segments 66 that are angularly arranged around the circumference of the output shaft 24. Alternating magnetic layers 50″ can be separated by the insulating layers 52 such that a radial surface 54 of the magnetic layers 50″ abuts a radial surface 56 of the insulating layers 52. In addition, the individual magnetic segments 66 of separate magnetic layers 50″ can be separated by axially-extending insulating layers 52′.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. A rotor assembly included in an electric motor, comprising:
a magnetic layer, including an additive manufacturing magnetic substrate, coupled to an output shaft of an electric motor; and
an insulating layer, including an additive manufacturing insulating substrate, coupled to the output shaft axially adjacent to the magnetic layer.

2. The rotor assembly recited in claim 1, further comprising an electrically-controlled turbocharger.

3. The rotor assembly recited in claim 1, wherein the magnetic layer has an axial length that is greater than an axial length of the insulating layer.

4. The rotor assembly recited in claim 1, wherein the insulating layer is electrically-insulating and thermally conductive.

5. The rotor assembly recited in claim 1, wherein the insulating layer comprises aluminum nitride.

6. The rotor assembly recited in claim 1, wherein the insulating layer is between 1 micrometer (μm) and 2 μm in axial thickness.

7. The rotor assembly recited in claim 1, wherein the insulating material initially exists as a powder.

8. The rotor assembly recited in claim 1, wherein the magnetic layer is between 1 millimeter (mm) and 2 mm in axial thickness.

9. The rotor assembly recited in claim 1, wherein the magnetic layer comprises neodymium, iron, and boron, or as samarium cobalt.

10. The rotor assembly recited in claim 1, wherein the magnetic layer initially exists as a powder.

11. The rotor assembly recited in claim 1, further comprising a coating applied on an axial surface of the magnetic layer and the insulating layer.

12. The rotor assembly recited in claim 1, further comprising one or more sleeves concentrically positioned relative to the magnetic layer and the insulating layer.

13. A rotor assembly included in an electric motor, comprising:
a magnetic layer, including an additive manufacturing magnetic substrate, coupled to an output shaft of an electric motor; and
an insulating layer, including an additive manufacturing insulating substrate, coupled to the output shaft such that a radial surface of the magnetic layer abuts a radial surface of the insulating layer.

14. The rotor assembly recited in claim 13, wherein the magnetic layer is elongated and extends axially along the output shaft.

15. The rotor assembly recited in claim 13, wherein the magnetic layer has an axial length that is greater than an axial length of the insulating layer.

16. The rotor assembly recited in claim 13, wherein the insulating layer is electrically-insulating and thermally conductive.

17. The rotor assembly recited in claim 13, wherein the insulating layer is between 1 micrometer (μm) and 2 μm in axial thickness.

18. The rotor assembly recited in claim 13, wherein the magnetic layer is between 1 millimeter (mm) and 2 mm in axial thickness.

19. The rotor assembly recited in claim 13, further comprising a coating applied on an axial surface of the magnetic layer and the insulating layer.

20. A rotor assembly included in an electric motor, comprising:
a magnetic layer, including an additive manufacturing magnetic substrate, that is elongated and extends from one end of the rotor to another end of the rotor, coupled to an output shaft of an electric motor; and
an insulating layer, including an additive manufacturing insulating substrate, that is elongated and extends from one end of the rotor to another end of the rotor, coupled to the output shaft such that the magnetic layer abuts the insulating layer.
